(19) United States
(12) Patent Application Publication
(10) Pub. No.: US 2016/0140950 A1
(43) Pub. Date: May 19, 2016

(54) Method and System for Real-Time Synthesis of an Acoustic Environment

(71) Applicant: The Board of Trustees of the Leland Stanford Junior University, Palo Alto, CA (US)

(72) Inventors: Jonathan S. Abel, Menlo Park, CA (US); Konstantine R. Buhler, Lake Forest, IL (US)

(21) Appl. No.: 14/936,377

(22) Filed: Nov. 9, 2015

Related U.S. Application Data
(60) Provisional application No. 62/079,734, filed on Nov. 14, 2014.

(51) Int. Cl. G10K 15/08; G06F 17/30

(52) U.S. Cl. CPC G10K 15/08; G06F 17/3074

(57) ABSTRACT

A method or system is provided for real-time synthesis in a rehearsal space of an acoustic environment of a target space. Microphones, pick-ups or other devices are used to separately record the singing or instruments. These “dry” instrument signals are sent to a remote site, where they are processed to imprint the acoustics of the desired location. Performers in a rehearsal space with loudspeakers are close-miked. The signals collected would be sent to a processing center via a low-latency internet connection, where the signals would be processed according to the response of the target acoustic space, corrected by the known acoustics and loudspeaker configuration of the rehearsal space. The processed signals would then be sent back to the rehearsal space, where they would be amplified and played over the loudspeakers, thereby giving the impression that the performers are performing in the target acoustic space.

### CROSS REFERENCE TO RELATED APPLICATIONS

This application claims priority from U.S. Provisional Patent Application 62/079,734 filed Nov. 14, 2014, which is incorporated herein by reference.

### FIELD OF THE INVENTION

This invention relates methods and systems for simulating acoustics.

### BACKGROUND OF THE INVENTION

There are a number of contexts in which it is useful to simulate the acoustics of a particular space. Musical performers interact with the acoustics of the space, changing their tempo and phrasing, the way pitches are modulated, and even their dynamics. As a result, when preparing for a concert in a venue with unique acoustics, it is desirable to practice in that acoustic space to understand how the space will respond to the performance, and how the performance needs to be modified to accommodate the space. In addition, there are many musical pieces which were written for particular spaces, and incorporate the acoustic character of the space into the piece. The difficulty is that it is often not possible to have access to the venue while preparing for a concert; it might be in a different city or booked for other performances.

Thus there is a need for the ability to transform the acoustics of a practice space into that of any number of target performance venues.

Systems which artificially simulate the acoustics of spaces exist. A system developed by David Greisinger with Lexicon in Boston [1], and another system developed by Meyer Sound in Berkeley, operate in specially constructed acoustically neutral rooms outfitted with several hundred loudspeakers and microphones [2]. Such configurable spaces successfully simulate the needed acoustics, but can be prohibitively expensive to construct and maintain.

Alternatively a performer can process singing using a digital audio workstation configured with a plug-in such as Altiverb [3] manufactured by AudioEase to imprint the acoustics of one of the spaces in their library on the dry recorded signal. This “wet” signal can then be heard over headphones. Many performers are uncomfortable using headphones, and if there are a group of performers, it is preferred to not use headphones so the performers can better hear each other. If the simulated acoustics is played over loudspeakers, there are two potential drawbacks. First, feedback between the loudspeaker and microphone can modify the sound, and second, the acoustics of the practice space will also be imprinted on the loudspeaker signal.

It is thus an object of the present invention to provide a method and system for transforming the acoustics of an existing practice space into that of a desired space using a small number of loudspeakers and microphones, and to do so without the need to construct a special, acoustically neutral space.

### SUMMARY OF THE INVENTION

The idea behind the invention is to do the processing remotely so that no specialized equipment, processing or acoustical treatment is needed in the rehearsal space. The invention combines microphones, pick-ups or other devices used to separately record the singing or instruments. These “dry” instrument signals are sent to a remote site, where they are processed to imprint the acoustics of the desired location, preferably corrected to account for the measured acoustics of the rehearsal space and modified in a perceptually transparent way so as to obscure details of the target space impulse response.

Performers in a rehearsal space with loudspeakers are close-miked (outfitted with microphones so as to pick up their voice or instrument with much more energy than other sounds in the space). The signals collected would be sent to a processing center via a low-latency internet connection, where the signals would be processed according to the response of the target acoustic space, corrected by the known acoustics and loudspeaker configuration of the rehearsal space. The processed signals would then be sent back to the rehearsal space, where they would be amplified and played over the loudspeakers, thereby giving the impression that the performers are performing in the target acoustic space.

An embodiment of the inventive system comprises a number of elements: the rehearsal space with the microphones, loudspeakers, associated preamplifiers and amplifiers, and signal digitization, transmission and reception means; and the processing center with signal processing capability and database of target (performance) space and rehearsal space acoustic characteristics, along with data transmission and reception devices.

An embodiment of the inventive method involves the steps of measuring the acoustics of the performance space and rehearsal space; receiving, transmitting and processing instrument or voice signals to imprint on the signals the acoustics of the target space; and transmitting the processed signals for playback over loudspeakers in the rehearsal space.

In one embodiment (FIG. 1), the present invention provides a method or system for real-time synthesis in a rehearsal space of an acoustic environment of a target space. A remote server is used with access to a database containing digitally stored target space acoustic information. This information includes a target room impulse response related to the target space. The remote server receives acoustic information related to the rehearsal space. From the rehearsal space acoustic information and the target space acoustic information a processing impulse response is derived. In the rehearsal space audio is detected from a performer or an instrument in the rehearsal space a rehearsal space audio signal. The rehearsal space audio signal is substantially free of the acoustics of the rehearsal space. At the remote server location the processing impulse response is imprinted onto the rehearsal space audio signal using a computer-implemented program executable on the remote server. The imprinted audio is sent back to the rehearsal space, where it is played back in the rehearsal space.

Specifically, the rehearsal space has longer reverberation times than that of the target space. The processing impulse response is substantially statistically independent from impulse responses of the rehearsal space, and which, if imprinted on the audio played in the rehearsal space, approximately reproduces an aspect of the acoustics of the target space. The step of detecting the rehearsal space audio signal uses a closed-microphone. The step of detecting the rehearsal space audio signal could include using a transducer in contact with the instrument. The step of detecting the rehearsal space audio signal could include using a direct output signal from the instrument.

### BRIEF DESCRIPTION OF THE DRAWINGS

FIG. 1 shows a system and method according to an exemplary embodiment of the invention.

FIG. 2 shows a room response according to an exemplary embodiment of the invention.

FIG. 3 shows an impulse response according to an exemplary embodiment of the invention.

FIG. 4 shows an response amplitude according to an exemplary embodiment of the invention.

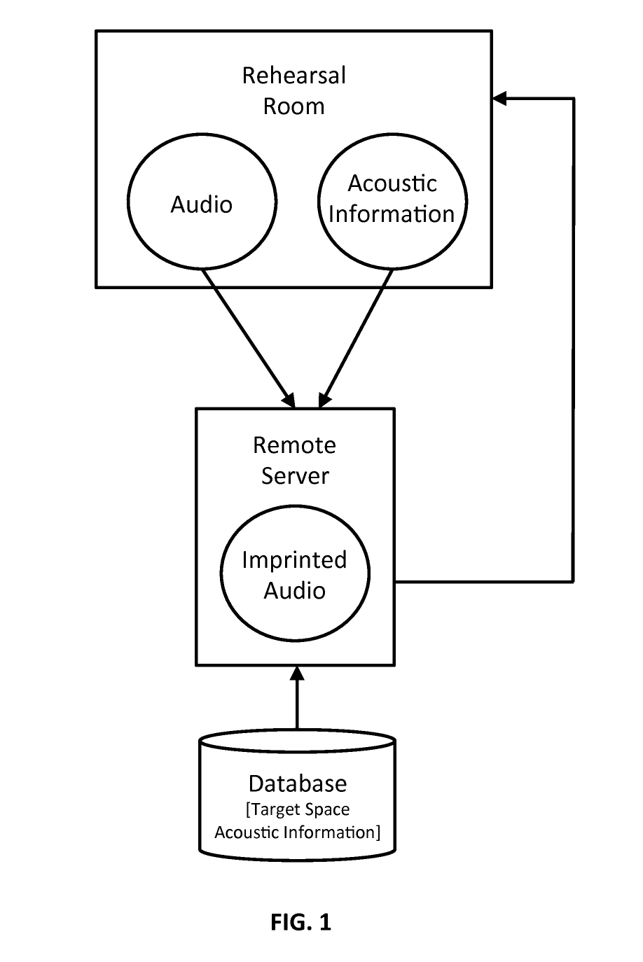

### DETAILED DESCRIPTION OF THE INVENTION

The step of target (performance) space acoustics measurement may be accomplished by recording a balloon pop, starter pistol, orchestral whip, hand clap or other transient sound with the sound source and microphone in any number of sound source and listener positions within the space. The recording may then be processed according to the method described in Abel, et al. “Balloon pop . . . ” [4] to convert the measurements into a set of room acoustics characteristics, from which a set of statistically independent room impulse responses may be derived. Alternatively, sine sweeps or similar test signals may be used to drive loudspeakers to measure room impulse responses of the target space in a manner such as described in Farina, “Recording Room Acoustics for Posterity.” Such impulse responses may be analyzed to understand the characteristics needed to derive the needed set of statistically independent room impulse responses.

The step or rehearsal space acoustic measurement may be similarly carried out, preferably using the rehearsal space loudspeakers to generate the test signals, and recording the test signal responses at anticipated performer locations.

The step of processing recorded audio for presentation over loudspeakers in the rehearsal space is accomplished by convolving the recorded performer tracks with sets of statistically independent impulse responses so as to imprint the target room acoustics on the performer tracks. Such processing would have the effect of placing the performer in the acoustic of target space when heard over headphones. By convolving the recorded signals with statistically independent but perceptually similar impulse responses, the loudspeaker signals become statistically independent, and the feedback between the microphones and loudspeakers is reduced. In this way, very reverberant spaces may be simulated. As few as two microphones, say, in a Blumlein pair, or as many as one close microphone on each performer, combined with in the range of two to sixteen loudspeakers can produce excellent results, with about eight loudspeakers arranged about the performers being more than adequate for a small-recital-hall-sized rehearsal space.

The rehearsal space will have it's own acoustics, and the processing can be designed to anticipate the rehearsal space acoustics, provided that the rehearsal space is less reverberant than the target space. The energy envelope of the convolution of the rehearsal space response and the impulse response used in the processing is the convolution of the response energy envelopes. As room impulse responses maintain roughly exponential energy envelopes, the combination of the rehearsal space acoustics and the processing response can be made to approximate that of the target space by forming the processing response as the target room impulse response, with a bit of the “dry” signal added in. The idea is that the additional more quickly decaying rehearsal space response generated by the dry signal would provide the needed energy difference in the beginning of the system response.

The reverberation server performs the steps of receiving, processing and transmitting the recorded and processed audio. It can optionally retain the dry and wet signals for later use. A system such as described in Lopez-Lezcano, et al. in LAC2013 [5] could be used to process the audio, and JackTrip and other software such as developed by the SoundWIRE group at CCRMA, Stanford University, would provide the needed low-latency internet connection for transmitting and receiving audio. Note that typically larger, more reverberant spaces are modeled, and the round trip latency, say about 40 milliseconds between San Francisco and Miami, can be absorbed in the target space reverberation pre-delay.

Finally, the step of scrambling the phase of the loudspeaker signals can be taken so as to obscure the details of the target space impulse response, while retaining its perceptually relevant features.

### DETAILED EXAMPLES

Two aspects of an embodiment of the invention are now described in detail, processing of recorded balloon pop responses into impulse responses, and designing an impulse response to produce a desired perceived room acoustic in a manner that accounts for the acoustics of the space.

### A. Balloon Pop Processing

The processing of balloon pop recordings into impulse responses follows the process outlined in [4]. A recorded balloon pop is first analyzed to estimate the density of echoes as a function of time, and the spectrogram of the balloon pop response is formed to estimate the response energy as a function of time and frequency. Since the balloon pop would have been recorded in the presence of additive noise, the band energies as a function of time are extended to below the noise floor using a process similar to that described in [6].

The echo density is then used to create a set of statistically independent noise sequences, each of which is roughly spectrally white over any given running window. The noise sequences generated above are then filtered into bands, and the energy in each band as a function of time is noted. The noise sequence bands are then scaled by the ratio of their raw band energy as a function over time to the corresponding balloon pop band energy as a function of time. So as to account for the spectrum of the balloon pop, the band energies are normalized by the balloon pop band energies at the time of the balloon pop.

The Matlab script bp2ir.m is attached below in the appendix, and details an embodiment of this method. Note that the analyzed space was assumed to have full echo density from the impulse response start.

### B. Room Response Processing

We now describe the processing of the desired room impulse response to take into account the extant rehearsal room acoustics.

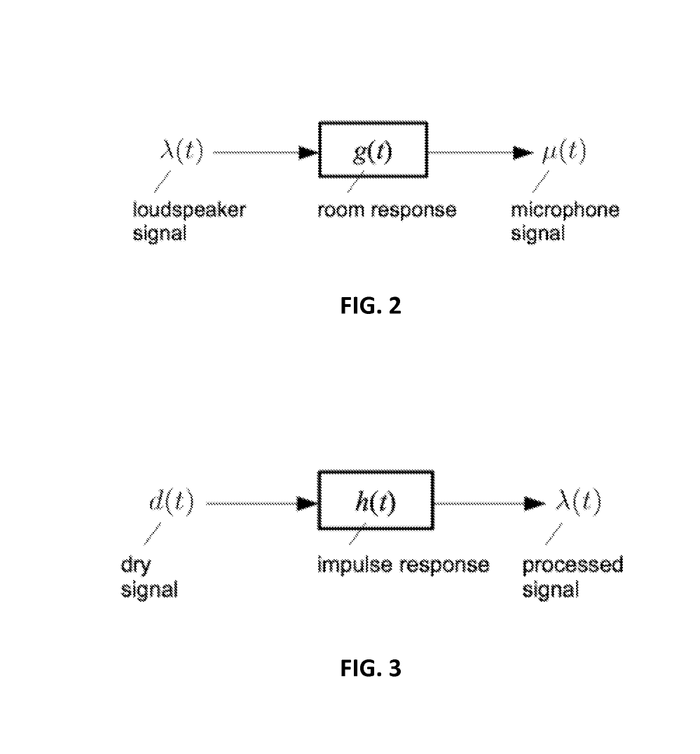

As shown in FIG. 2, a signal λ(t) drives a loudspeaker, and the resulting audio appears at a microphone in the room, which records the signal μ(t), the loudspeaker signal imprinted with the room acoustics represented by the impulse response g(t),

μ(t)=(g*λ)(t), (1)

where * represents convolution. As depicted in FIG. 3, the idea is to process the dry signal d(t) via an impulse response h(t) to produce the microphone signal which has the perceptual characteristics of the dry signal heard in the desired room. To do this the impulse response h(t) is designed so that when it is convolved with the rehearsal room response g(t), the energy envelope as a function of frequency of the resulting impulse response (g*h) (t) matches that of the desired room response.

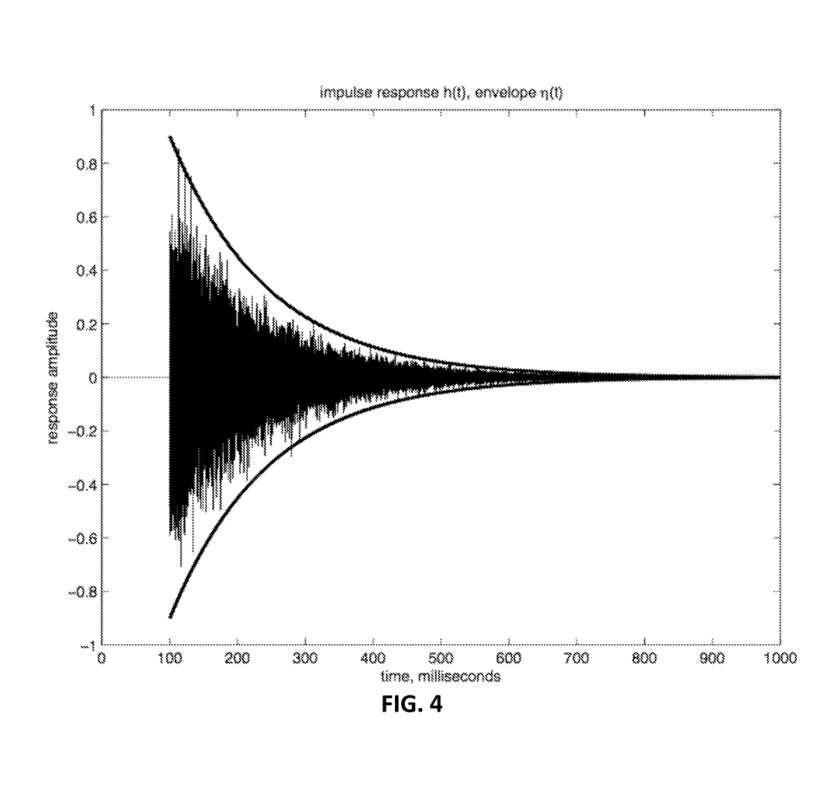

We first argue that the energy envelope of the convolution of a pair of impulse responses is the convolution of their energy envelopes. Roughly speaking, a room impulse response may be written as a noise sequence representing a sequence of reflections ν(t) imprinted with an amplitude envelope η(t), as illustrated in FIG. 4,

h(t)=η(t)ν(t) (2)

The amplitude envelope is generally a function of time and frequency, but for clarity of presentation, we assume that the amplitude envelope is only a function of time. Since the processing is linear, the different frequency bands of room impulse responses can be treated separately, and the argument presented below extends to the case of a frequency-dependent amplitude envelope.

Consider the convolution c(t) of two room responses, h₁(t) and h₂(t),

c(t)=(h₁*h₂)(t), (3)

where the room responses are the products of amplitude envelopes and corresponding noise sequences,

h₁(t)=η₁(t)ν₁(t),h₂(t)=η₂(t)ν₂(t). (4)

The convolution then may be written as

$$c ( t ) = {\sum }_{τ} {v}_{1} ( τ ) {η}_{1} ( τ ) {v}_{2} ( t - τ ) {η}_{2} ( t - τ ) . \qquad ( 5 )$$

The energy envelope of the convolution c(t) is the expected value of the square sample sequence,

$$E \{ {c}^{2} ( t ) \} = E \{ [ {\sum }_{m} {v}_{1} ( m ) {η}_{1} ( m ) {v}_{2} ( t - m ) {η}_{2} ( t - m ) ] [ {\sum }_{n} {v}_{1} ( n ) {η}_{1} ( n ) {v}_{2} ( t - n ) {η}_{2} ( t - n ) ] \} . \qquad ( 6 )$$

Assuming the noise sequences ν₁(t) and ν₂ (t) are independent of each other and composed of i.i.d. Gaussian samples with zero mean and variance σ², only certain samples above, e.g., when n=m, are nonzero, giving

$$E \{ {c}^{2} ( t ) \} = {\sum }_{m} {σ}^{2} {η}_{1}^{2} ( m ) {η}_{2}^{2} ( t - m ) + 2 {σ}^{2} {η}_{1}^{2} ( t ) {η}_{2}^{2} ( t ) . \qquad ( 7 )$$

The energy envelope of the convolution of two room responses therefore approximates the convolution of the energy envelopes. As a result, the impulse response applied to the dry signal h(t) should be the desired room response, scaled according to an amplitude envelope producing a so-called corrected response. This corrected response is designed so that the rehearsal room energy envelope convolved with its energy envelope approximates the desired room response energy envelope.

As an example, consider a rehearsal room energy envelope ηᵣ²(t) and a desired wet response energy envelope η_{d}²(t) described by exponential decays, as is often the case,

ηᵣ²(t)=βᵣ²exp{−2t/τᵣ}, (8)

η_{d}²(t)=β_{d}²exp{−2t/τ_{d}}, (9)

with τᵣ and τ_{d} being the rehearsal room and desired reverberation decay time constants, respectively. If the processed impulse response energy were given by

ηₚ²(t)=γₚ[(δ(t)+βₚ²exp{−2t/τ_{d}}] (10)

where the dry signal present in the space is represented by the unit pulse δ(t), and γₚ is a scalar gain, then the reverberation energy envelope is given by

$$\begin{matrix}\frac{1}{{γ}_{p}} {η}_{r}^{2} * {η}_{p}^{2} = {β}_{r}^{2} exp \{ - 2 t / {τ}_{r} \} + {β}_{p}^{2} {β}_{r}^{2} exp \{ - 2 t \text{/} {τ}_{r} \} * exp \{ - 2 t \text{/} {τ}_{r} \} , & ( 11 ) \\ = {β}_{r}^{2} [ 1 - \frac{2 {β}_{p}^{2} {τ}_{d} {τ}_{r}}{{τ}_{d} - {τ}_{r}} ] exp \{ - 2 t \text{/} {τ}_{r} \} + {β}_{p}^{2} * exp \{ - 2 t \text{/} {τ}_{d} \} , & ( 12 )\end{matrix}$$

which reduces to

$$\frac{1}{{γ}_{p}} {η}_{r}^{2} * {η}_{p}^{2} = {β}_{p}^{2} * exp \{ - 2 t \text{/} {τ}_{d} \} \qquad ( 13 )$$

when the wet amplitude of the correction impulse response is a kind of harmonic difference between the desired and rehearsal space time constants,

$${β}_{b}^{2} = \frac{{τ}_{d} - {τ}_{r}}{2 {τ}_{d} {τ}_{r}} . \qquad ( 14 )$$

In this way, by setting the processing to a particular wet-dry mix of the desired response (which could be frequency dependent, by using frequency-dependent decay rates), a rehearsal space can be corrected. What's happening is that the dry signal initiates the reverberation in the rehearsal space, and over time the shorter decay time of the rehearsal space is replaced by the convolution of the wet portion of the rehearsal space and the desired room response.

Finally, it should be pointed out that this approach will be effective only for rehearsal spaces which have longer reverberation times than that of the desired room response, τ_{d}>τᵣ.

APPENDIX
bp2ir.m

% BP2IR - process balloon pop into impulse response.
%% initialization
% balloon pop response
fnames = [ ...

| | |
|---|---|
| ’MC110304_BRN’; | % Memorial Church 110304 near response name, string |
| ’MC110304_BRF’]; | % Memorial Church 110304 far response name, string |

| | |
|---|---|
| fid = 2; | % recording processed, index |
| chan = 2; | % recording channel processed, index |

% analysis, synthesis parameters
ft = 125 * 2.\hat{ } ([−0.25:0.5:7.25]); % impulse response filterbank band edge frequencies, Hz
nbands = length(ft)+1; % impulse response filterbank band count, bands
order = 5; % filterbank filter order, poles

| | |
|---|---|
| beta = 10; | % band energy smoothing filter duration, milliseconds |
| eta = 200; | % noise floor estimation window length, milliseconds |
| phi = 50; | % band decay rate estimation smoothing length, milliseconds |

| | |
|---|---|
| delta0 = 15; | % band decay rate estimation window start level, dB |
| delta1 = 5; | % band decay rate estimation window end level, dB |

| | |
|---|---|
| taud = 20; | % dry signal peroll, milliseconds |
| tauw = 7; | % wet signal predelay, milliseconds |
| phiw = 2; | % wet signal onset duration, milliseconds |

```
rchan = 16; % output channel count, channels
rpath = ’Memorial Church impulse responses/’; % output impulse response directory, path
nt60 = 96; % normalization window growth time, integer seconds
ntau = 8; % impulse response duration, seconds
%% load, extract balloon pop response
% load balloon pop response
fname = deblank(fnames(fid,:));
[brraw, fs] = wavread([fname, ’.wav’]); % signal, amplitude; sampling rate, Hz
nchan = size(brraw,2); % channel count, channels
% extract balloon pop response
[level istart] = max(abs(brraw));
level = max(level);
istart = min(istart);
preroll = round(taud*fs/1000);
br = brraw(istart−preroll:end,:) / level;
btaps = length(br);
br = br(1:btaps,chan);
figure(1); ftgram(br, fs, ’rir’);
drawnow;
% form wet response
predelay = round(tauw*fs/1000);
brw = flipud(irwindow(flipud(br), btaps − preroll − predelay, round(phiw*fs/1000)));
%% design filter bank
% form band center frequencies
fb = [0 exp(mean(log([ft(1:end−1); ft(2:end)]))) fs/2];
% design band filters
bL = zeros(order+1,nbands−1);
bH = zeros(order+1,nbands−1);
aX = zeros(order+1,nbands−1);
for i = [1:nbands−1],
% low pass
[b, a] = butter(order, ft(i)*(2/fs));
bL(:,i) = b′;
aX(:,i) = a′;
% high pass
[b, a] = butter(order, ft(i)*(2/fs), ’high’);
bH(:,i) = b′;
end;
%% estimate band energies
% form balloon response bands
brb = br*ones(1,nbands);
for i = [1:nbands−1],
brb(:,i) = filtfilt(bL(:,i), aX(:,i), brb(:,i));
for j = [i+1:nbands],
brb(:,j) = filtfilt(bH(:,i), aX(:,i), brb(:,j));
end;
end;
% estimate energy profile
staps = round(beta/2 * fs/1000);
bS = hanning(2*staps−1)/sum(hanning(2*staps−1));
brbe = real(sgrt(fftfilt(bS, [zeros(staps,nbands); brb.\hat{ }2; zeros(staps,nbands)])));
brbe = brbe(2*staps−1+[1:btaps],:);
%% estimate band T60s; extend band energy profiles
% estimate noise floor
etaps = round(eta*fs/1000);
basis = [ones(etaps,1) [1:etaps]′/fs];
theta = basis \ (20*log10(brbe(end+[1−etaps:0],:)));
nu = theta(1,:) + theta(2,:)*etaps/fs;
% smooth band envelopes
ftaps = round(phi*fs/1000);
bF = hanning(2*ftaps−1)/sum(hanning(2*ftaps−1));
brbes = sqrt(fftfilt(bF, [zeros(ftaps,nbands); brbe.\hat{ }2; zeros(ftaps,nbands)]));
brbes = brbes(2*ftaps−1+[1:btaps],:);
% extend level estimates
figure(2);
ntaps = round(ntau*fs)+preroll;
brbee = zeros(ntaps, nbands);
rt60 = zeros(1,nbands);
for i = [1:nbands],
    % find noise floor arrival
    index0 = find(20*log10(brbes(preroll:end,i)) < nu(i) + delta0, 1) + preroll;
    index1 = find(20*log10(brbes(preroll:end,i)) < nu(i) + delta1, 1) + preroll;
    index = [index0:index1];
    % estimate decay parameters
    basis = [ones(length(index),1) (index′−1)/fs];
    theta = basis \ (20*log10(brbes(index,i)));
    % extend band energy
    nfade = index1−index0;
    fade = [ones(index0,1); 0.5+0.5*cos(pi*[1:nfade]′/nfade); zeros(ntaps−index1,1)];
    tempe = 10.\hat{ }([ones(ntaps,1) [1:ntaps]′/fs] * theta/20);
    tempm = [brbe(:,i); zeros(ntaps−btaps,1)];
    brbee(:,i) = (1−fade).*tempe + fade.*tempm;
    % form rt60
    rt60(i) = −60/theta(2);
    % plot extension
    figure(2);
    plot([0:btaps−1]*1000/fs, 20*log10(brbe(:,i))+20, ’−’, ...
        [0:ntaps−1]*1000/fs, 20*log10(brbee(:,i))+20, ’−’, ...
        [index0 index1]*1000/fs, −20, ’o’); grid;
    title(int2str(i));
    ylim([−120 0]);
    drawnow;
end;
pause(1);
close(2);
drawnow;
%% synthesize impulse response
disp(time),
for c = [1:rchan],
    % display progress
    fprintf(’.’);
    % form noise bands
    noise = randn(ntaps,1)*ones(1,nbands);
    for i = [1:nbands−1],
        noise(:,i) = filtfilt(bL(:,i), aX(:,i), noise(:,i));
        for j = [i+1:nbands],
            noise(:,j) = filtfilt(bH(:,i), aX(:,i), noise(:,j));
        end;
    end;
    % estimate noise band energy profile
    noisebe = sqrt(fftfilt(bS, [zeros(staps,nbands); noise.\hat{ }2; zeros(staps,nbands)]));
    noisebe = noisebe(2*staps−1+[1:ntaps],:);
    % window noise bands
    irbw = noise .* brbee ./ noisebe;
    % form equalized, wet impulse response channel
    weight = mean(noisebe) ./ brbe(preroll,:);
    irq = irbw*weight′;
    % normalize, window signal
    irn = irq(preroll+1:end) .* exp(log(1000)*[0:ntaps−preroll−1]′/(nt60*fs));
    irw = flipud(irwindow(flipud(irn), ntaps−preroll−predelay, round(phiw*fs/1000)));
    % save impulse response channel
    scale = 0.9/max(abs(irw));
    rname = [’ir’, fname([1 2 (end−3):end]), ’_N’, int2str(nt60), ’_W’, int2str(c)];
    wavwrite(scale*irw, fs, 16, [rpath, rname, ’.wav’]);
end;
fprintf(’\n’);
```

### REFERENCES

[1] LARES concert hall sound enhancement system, http://en.wikipedia.org/wiki/LARES, accessed Aug. 7, 2014.
[2] Meyer Constellation concert hall acoustic system, http://www.meyersound.com/products/constellation/, accessed Aug. 7, 2014.
[3] Altiverb convolutional reverberator plug-in, http://www.audioease.com/Pages/Altiverb/, accessed Aug. 7, 2014.
[4] Jonathan S. Abel, Nicholas J. Bryan, Patty P. Huang, Miriam A. Kolar, and Bissera V. Pentcheva, “Estimating Room Impulse Responses from Recorded Balloon Pops,” in Proc. AES 129th Convention, San Francisco, November 2010.
[5] Fernando Lopez-Lezcano, Travis Skare, Michael J. Wilson, Jonathan S. Abel, “Byzantium in Bing: Live Virtual Acoustics Employing Free Software” in Proc. Linux Audio Conference, Graz, Austria, 2013.
[6] Nicholas J. Bryan, Jonathan S. Abel. “Methods For Extending Room Impulse Responses Beyond Their Noise Floor,” in Proc. 129th Audio Engineering Society Convention, San Francisco, Nov. 4-7, 2010.

What is claimed is:

1. A method for real-time synthesis in a rehearsal space of an acoustic environment of a target space, comprising:
(a) providing a remote server with access to a database containing digitally stored target space acoustic information comprising a target room impulse response related to the target space;
(b) receiving by the remote server acoustic information related to the rehearsal space;
(c) deriving from the rehearsal space acoustic information and the target space acoustic information a processing impulse response;
(d) detecting in the rehearsal space audio from a performer or an instrument in the rehearsal space a rehearsal space audio signal, wherein the rehearsal space audio signal is substantially free of the acoustics of the rehearsal space;
(e) imprinting at the remote server location the processing impulse response onto the rehearsal space audio signal using a computer-implemented program executable on the remote server;
(f) sending the imprinted audio back to the rehearsal space; and
(g) playing back the imprinted audio in the rehearsal space.

2. The method as set forth in claim 1, wherein the rehearsal space has longer reverberation times than that of the target space.

3. The method as set forth in claim 1, wherein the processing impulse response is substantially statistically independent from impulse responses of the rehearsal space, and which, if imprinted on the audio played in the rehearsal space, approximately reproduces an aspect of the acoustics of the target space.

4. The method as set forth in claim 1, wherein the step of detecting the rehearsal space audio signal comprises using a closed-microphone.

5. The method as set forth in claim 1, wherein the step of detecting the rehearsal space audio signal comprises using a transducer in contact with the instrument.

6. The method as set forth in claim 1, wherein the step of detecting the rehearsal space audio signal comprises using a direct output signal from the instrument.
